(19) United States
(12) Patent Application Publication
(10) Pub. No.: US 2005/0000915 A1
(43) Pub. Date: Jan. 6, 2005

(54) In situ water treatment

(76) Inventors: Hirotsugu Yokosawa, Setagaya-ku (JP); Kiyoshi Yokokura, Setagaya-ku (JP)

Correspondence Address: Bruce A. Jagger;BRUNTON & JAGGER, P.O. Box 29000, Glendale, CA, 91209-9000, US

(21) Appl. No.: 10/863,913

(22) Filed: Jun. 9, 2004

Related U.S. Application Data
(60) Provisional application No. 60/484,839, filed on Jul. 1, 2003.

(51) Int. Cl. C02F 1/68

(52) U.S. Cl. 210/749

(57) ABSTRACT

A method of abating water pollution wherein the body of polluted water generally has a plurality of regions. At least one of the characteristics of the pollution or the movement of the water is different in the different regions. An inventory of functional agents is maintained. Each functional agent has the ability to remediate at least one form of pollution. The functional agents are placed in a case member to form a pollution abatement package. The package is placed in the body of water and is allowed to move unattended within the body of water. The characteristics of the package are selected so that the package will move unattended to the region where the characteristics of the package are matched to the characteristics of the region. Different regions may require packages with different characteristics. The case member is composed of separate case elements. An inventory of various different case elements is maintained so that a case member having a particular set of desired characteristics such as, for example, shape, size, and density, can be selected to meet the requirements of a particular region in a body of polluted water.

### RELATED APPLICATION

This application claims the benefit of U.S. Provisional Application No.: 60/484,839, filed Jul. 01, 2003.

### BACKGROUND OF THE INVENTION

1. Field of the invention.

The invention relates in general to packages for in situ water treatment and the production and use of such in situ water treatment packages.

2. Description of the prior art.

It is well recognized that there is a need to improve water quality in natural waters such as rivers, lakes, marshes, seas, and oceans, and also in artificial water areas such as ponds, swimming pools, and the like. The use of various biological, chemical, and mechanical pollution abating functional agents had been proposed to reduce the levels of pollution in water. The nature of the pollution determines which pollution abating functional agents can be used to ameliorate the situation. Some functional agents, such as activated carbon, adsorb pollutants. Activated carbon, for example, is well know as a colorant remover. Various chelating resins and impregnated activated carbons are particularly well suited for removing heavy metals. Various bacterial and other organic pollutants can be removed by various aquatic plants and animals.

In the past, various methods have been adopted for the purpose of purifying and improving water quality in rivers, lakes, marshes, ponds and seas. These previous expedients have included aeration methods, biological membrane methods, soil trench methods, plant growing methods, and the like. Organic substances can be decomposed by water quality purification processing using the aeration method or the biological membrane method, while nitrogen compounds and phosphoric acid causing water bloom or other unfavorable phenomena cannot be removed by these methods. Generally, in order to improve water quality in rivers, lakes, marshes, and the like by these methods, very large systems or facilities with large power requirements had been required. Such large pollution abatement facilities are difficult and expensive to locate, build, and maintain.

Typically, previous pollution abatement expedients required that the body of polluted water be confined and passed through a bed or column containing one or more functional agents confined in such bed or column. The capital investment and operational costs of such installations are substantial.

Previous water improvement operations using living plants have experienced difficulty in decomposing organic substances. Also, caring for living plants requires a considerable investment in time and effort. Water quality improvement projects using soil trench methods typically suffer from low throughput rates, because soils generally exhibit poor water permeability. Satisfactory easy and simple pollution abatement methods generally do not exist for improving water quality in areas where water flow is slow and contaminants are easily accumulated in water.

Those skilled in the art have recognized a need to provide pollution abatement methods and articles that are lightweight, produced at low cost, easy to handle, inexpensive to maintain, tailorable to abate a particular pollution problem in a region of a body of polluted water, and will operate unattended. Such need has been particularly acute where a body of water contains regions where it flows slowly or is stagnated.

These and other difficulties of the prior art have been overcome according to the present invention.

### BRIEF SUMMARY OF THE INVENTION

Conventional water pollution abatement agents (functional agents) are effective when, according to the present invention, they are packaged and introduced into a body of polluted water in small, discrete, water pervious cases under conditions where the water is not forced through the cases. The packages during use are in the nature of inclusions in a matrix of polluted water. The body of polluted water is not confined with respect to the packages. The water is not forced to flow through or even past the packages. The cases can be insoluble, soluble, and/or biodegradable, as may be desired. Preferably, the volume of the body of water is at least ten times, and preferably at least 100 times, that of the package. For large bodies of water, particularly flowing water, the comparative volumes can be millions to one or more. The packages are small and light enough to be easily produced, handled, stored, and transported. They can, for example, be hand-carried into areas that are inaccessible to mechanized handling equipment. In general these packages are less than approximately 60 centimeters in their longest dimension, and weigh less than 10 pounds, preferably, less than 20 centimeters and 1 pound. Each of these packages is adapted to removing or otherwise abating a certain amount and type or types of pollution. For some applications it is not necessary to abate all of the pollution. The required degree of pollution abatement is accomplished by the addition of the number of small packages sufficient to accomplish the desired abatement. The nature and amount of pollution should be ascertained as a part of the process of determining the desired number and make-up of the pollution abatement packages. The composition of the functional agent or agents is selected from an inventory of different agents based on the nature of the pollutants that are to be abated. The functional agents are confined within cases that are preferably assembled from an inventory of case elements to provide a case having the desired form. These pollution abatement packages generally operate unattended and without the necessity of any capital installations. According to one particularly advantageous feature of the present invention, the pollution abating packages automatically seek out and linger in regions of higher pollution. Stagnant or slower flowing regions tend to be more polluted, both as to concentration and types of pollution. Structuring the packages so that they tend to move unattended through the faster flowing regions, and linger in the slower flowing regions tends to place the pollution abatement packages where the problems are the worst. Typically, the structuring of the packages involves at least selecting cases that exhibit a generally rounded form. This automatic pollution seeking capacity is highly advantageous. Depending on the application, various water quality improving materials can be provided within the package in addition to the functional agents. Such water quality improving materials include, for example, binders, fertilizers, pH modifiers, flotation devices, and the like. These materials do not directly abate the pollution to any significant degree, but they aid the functional agents in accomplishing their intended purpose.

Other objects, advantages, and novel features of the present invention will become apparent from the following detailed description of the invention when considered in conjunction with the accompanying drawings.

### BRIEF DESCRIPTION OF THE DRAWINGS

The present invention is a method for pollution abatement, and provides its benefits across a broad spectrum of pollution control applications. While the description which follows hereinafter and the accompanying drawings are representative of a number of such applications, they are not exhaustive. For the sake of brevity, other embodiments of the invention, which use the principals of the present invention are not specifically shown and described. Certain details have been left out so as to avoid obscuring the invention. The details left out are within the skill of a person of ordinary skill in the art. As those skilled in the art will recognize, the basic methods and packages taught herein can be readily adapted to many uses. It is applicant's intent that this specification and the claims appended hereto be accorded a breadth in keeping with the scope and spirit of the invention being disclosed despite what might appear to be limiting language imposed by the requirements of referring to the specific examples disclosed.

Referring particularly to the drawings for the purposes of illustration only and not limitation:

FIG. 1a corresponds to Example 1, and is a diagrammatic cross-sectional view of a preferred embodiment of a package wherein a water pervious insoluble case contains granular activated carbon as a functional agent for the removal of colorants from water.

FIG. 1b is a graph, the curve of which reflect the reduction in the concentration of colorant in water over time when subjected to treatment with the package of FIG. 1a.

FIG. 1c is a graph, the bars of which reflect the changes in the concentration of various heavy metals in water over time when subjected to treatment with the package of FIG. 1a.

FIG. 2a corresponds to Example 2, and is a diagrammatic cross-sectional view of a preferred embodiment of a package wherein a water pervious insoluble case contains impregnated activated carbon as a functional agent for the removal of colorants and heavy metals from water.

FIG. 2b is a graph, the curve of which reflects the effect of the package of FIG. 2a on the concentration of a colorant in water.

FIG. 2c is a graph, the bars of which reflect the changes in the concentration of various heavy metals in water over time when subjected to treatment with the package of FIG. 2a.

FIG. 3a corresponds to Example 3, and is a diagrammatic cross-sectional view of a preferred embodiment of a package wherein a water pervious insoluble case contains chelate resin as a functional agent for the removal of heavy metals from water.

FIG. 3b is a graph the curve of which reflects the effect of the package of FIG. 3a on the concentration of a colorant in water.

FIG. 3c is a graph, the bars of which reflect the changes in the concentration of various heavy metals in water over time when subjected to treatment with the package of FIG. 3a.

FIG. 4a corresponds to Example 4, and is a diagrammatic cross-sectional view of a preferred embodiment of a package wherein a water pervious insoluble case contains granular activated carbon and impregnated activated carbon as functional agents for the removal of colorants and heavy metals from water.

FIG. 4b is a graph the curve of which reflects the effect of the package of FIG. 4a on the concentration of a colorant in water.

FIG. 4c is a graph, the bars of which reflect the changes in the concentration of various heavy metals in water over time when subjected to treatment with the package of FIG. 4a.

FIG. 5a corresponds to Example 5, and is a diagrammatic cross-sectional view of a preferred embodiment of a package wherein a water pervious insoluble case contains granular activated carbon, impregnated activated carbon, and a chelate resin as functional agents for the removal of colorants and heavy metals from water.

FIG. 5b is a graph the curve of which reflects the effect of the package of FIG. 5a on the concentration of a colorant in water.

FIG. 5c is a graph, the bars of which reflect the changes in the concentration of various heavy metals in water over time when subjected to treatment with the package of FIG. 5a.

FIG. 6a corresponds to Example 6, and is a diagrammatic cross-sectional view of a preferred embodiment of a package wherein a water pervious insoluble case contains fumic acid impregnated granular activated carbon as a functional agent for the removal of colorants and heavy metals from water.

FIG. 6b is a graph the curve of which reflects the effect of the package of FIG. 6a on the concentration of a colorant in water.

FIG. 6c is a graph, the bars of which reflect the changes in the concentration of various heavy metals in water over time when subjected to treatment with the package of FIG. 6a.

FIG. 7a corresponds to Example 7, and is a diagrammatic cross-sectional view of a preferred embodiment of a package wherein a water pervious soluble case contains granular montmorillonite as a functional agent for the removal of lead from water.

FIG. 7b is a graph, the curve of which reflects the change in the concentration of lead in water over time when subjected to treatment with the package of FIG. 7a.

FIG. 8a corresponds to Example 8, and is a diagrammatic cross-sectional view of a preferred embodiment of a package wherein a water pervious biodegradable case (bamboo section) contains anodonta mussels as a functional agent for the removal of organic material from water so as to reduce the chemical oxygen demand of the water.

FIG. 8b is a graph, the curve of which reflects the change in the chemical oxygen demand (COD) in polluted water over time when subjected to treatment with the package of FIG. 8a.

FIG. 9a corresponds to Example 9, and is a diagrammatic cross-sectional view of a preferred embodiment of a package wherein a water pervious biodegradable case contains rice chaff and aquatic worms as functional agents for the removal of water bloom from water.

FIG. 9b is a graph, the curve of which reflects the change in the concentration of water bloom in polluted water over time when subjected to treatment with the package of FIG. 9a.

FIG. 10a corresponds to Example 10, and is a diagrammatic cross-sectional view of a preferred embodiment of a package wherein a biodegradable water pervious case contains aquatic plants to show that they will grow in polluted water, particularly with the aid of plant nutrients in the water soluble case.

FIG. 10b is a chart, the bars of which reflect the growth of Japanese Parsley plants in water over time when treated with the package of FIG. 10a.

FIG. 11 is associated with Example 11, and is a diagrammatic cross-sectional view of a preferred embodiment of a package wherein alternative functional agents are employed serially.

FIG. 12 corresponds to Example 12, and is a chart that shows the effect as against controls of a silver-ion impregnated activated carbon in a water pervious polyethylene terephtalate case on the proliferation of bacteria in water.

FIG. 13 is a diagrammatic representation of a submerged pervious case and broad categories of materials that can be placed in such a case to form a package according to the present invention

FIG. 14 is a diagrammatic representation of a connected network of floated packages in a body of flowing water according to the present invention.

FIG. 15 is a diagrammatic representation of a laboratory bench scale experimental set up for testing the effectiveness of packages according to the present invention.

FIG. 16 is a diagrammatic representation of a pilot plant scale experimental set up with packages at the bottom of a column of water that was used in many of the specific examples.

FIG. 17 is a diagrammatic representation of a pilot plant scale experimental set up with packages floated in a column of water that was used in some of the specific examples.

FIG. 18 is a diagrammatic representation of a plurality of water pervious case elements and the assembly of selected case elements together to form cases of various rounded forms.

### DETAILED DESCRIPTION OF THE PREFERRED EMBODIMENTS

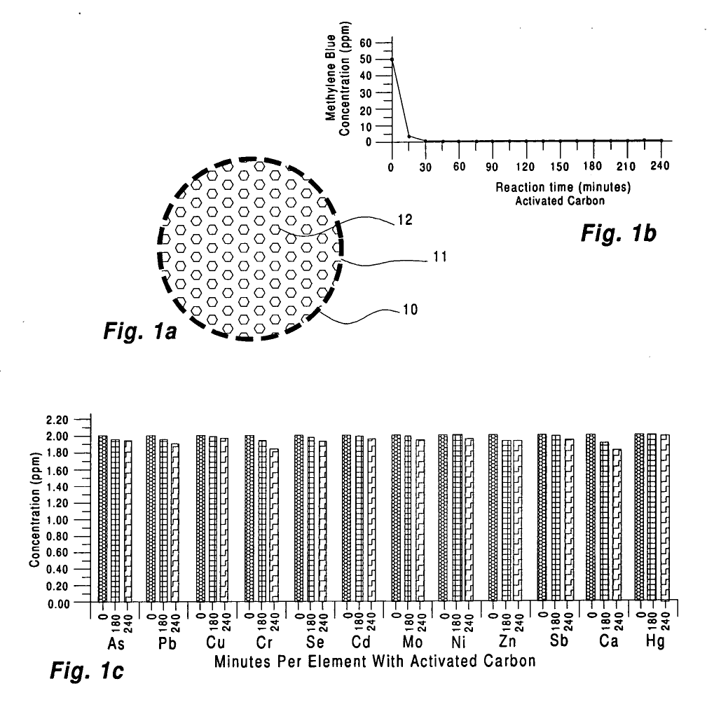

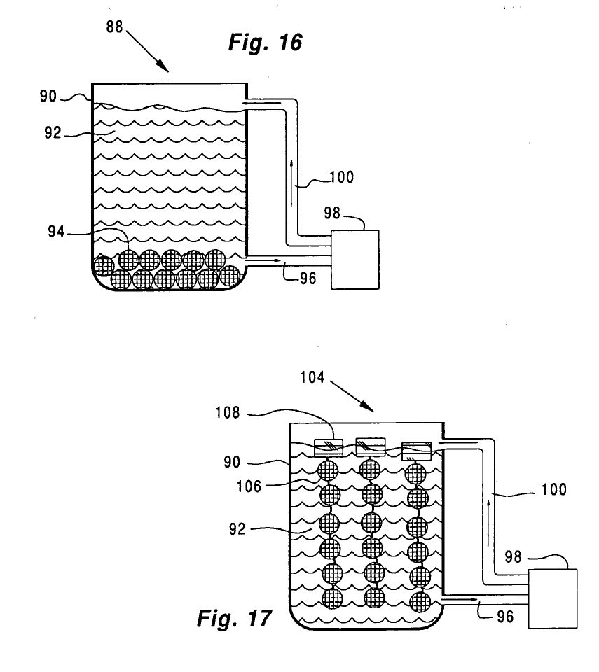

In each of the following examples, a package consisting of a functional agent encased within a pervious case was prepared and used to treat water. In each example, unless otherwise indicated, the package was thrown loose into a body of polluted water. The water was not forced through the package. The package, unless otherwise indicated, was allowed to move freely in the water. Where the functional agent was a finely divided material (powdered carbon or chelate resin) the fine agent was confined in a water permeable paper bag within the water pervious case. The paper had a high wet tear strength so that it did not fall apart in the water. It was the same paper that is conventionally used for tea bags. The effects on the levels of pollution as recorded in the following examples resulted from the free interaction of the package with the body of water, and not from any confinement of the package with respect to the body of water. The body of polluted water contained various organic, biological, and inorganic pollutants as indicated below. The Example numbers correspond to the FIG. numbers in the accompanying drawings. For example, FIG. 1a is a cross-sectional diagrammatic representation of the package used in Example 1. FIGS. 1b and 1c are charts that reflect the effects of the presence of the package on the levels of pollution in the body of water. FIGS. 16 and 17 diagrammatically represent the physical arrangements used in some of the following Examples. In FIGS. 16 and 17, a container 90 holds water 92 that has the composition indicated in the following Examples. Water 92 is circulated through an external circuit. A conduit 96 serves as an outlet for water 92. Pump 98 draws water 92 from the container 90 through conduit 96 and returns it to container 90 through return conduit 100. The system indicated generally at 88 in FIG. 16 includes loose cases, a typical one of which is shown at 94. The active pollution control agents are confined in cases 94. The system indicated generally at 104 in FIG. 17 includes cases 106 that are tethered to floats 108 in the body of the water 92. The tethered cases are above the bottom of the container 90. The active pollution control agents in system 104 are confined in cases of which 106 is typical.

In these Examples the water samples were prepared so as to simulate heavy metal polluted waste water. Generally, in addition to dissolved heavy metals, other pollutants are present in heavy metal contaminated waste water. Methylene blue was added to the heavy metal containing samples in these Examples to simulate these other pollutants. Unimpregnated activated carbon is not effective in removing heavy metals. It is, however, effective in removing some of the other pollutants that are typically found in combination with heavy metals. Activated carbon is about as effective at removing methylene blue as it is at removing the other pollutants that typically occur in heavy metal polluted waste water. Thus, the effectiveness of activated carbon in removing methylene blue accurately measures its effectiveness in removing other pollutants. Typically, activated carbon remediates such pollutants through physical adsorption.

Prior expedients that were previously proposed for the processing of heavy metal containing waste water generally required a series of two or more steps. According to the present invention, heavy metal containing waste water can be effectively processed in one step when the functional agents within the case are selected so as to remove substantially all of the pollutants. Typically, several different functional agents may be required to effectively remove all of the different pollutants from a particular body of water. When a plurality of functional agents are required, they are all enclosed within one case. As will be appreciated by those in the art, the following Examples teach that the various functional agents are effective when combined within one case. Those skilled in the art will appreciate from these Examples and the other teachings herein that pollution abatement packages used according to the present invention are very effective in abating various kinds of pollution.

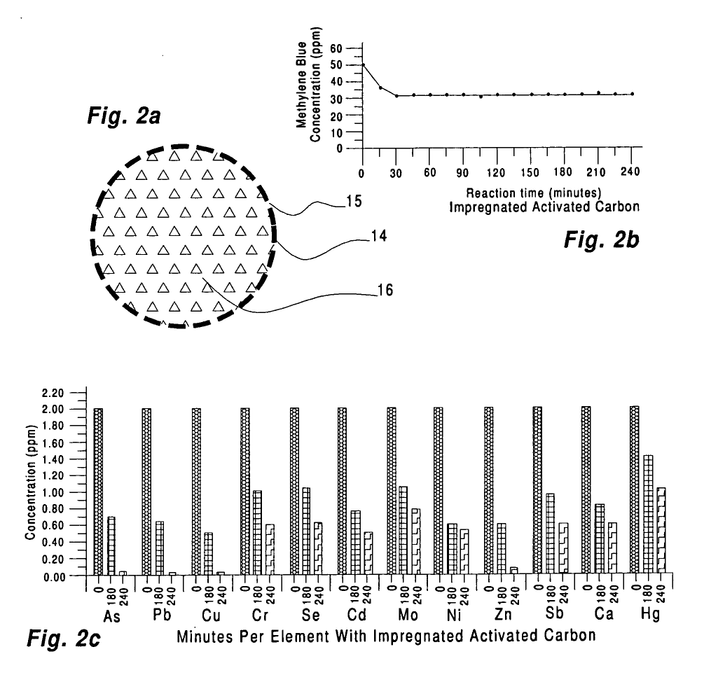

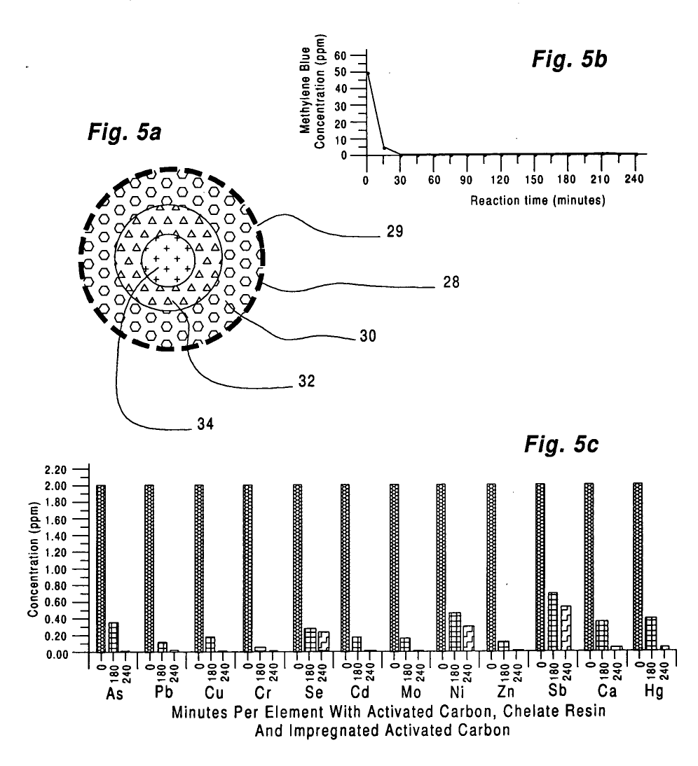

Examples 1 through 3 illustrate the effectiveness of activated carbon, impregnated activated carbon, and chelate resin, respectively, in abating particular types of pollution. Examples 4 and 5 illustrate that combinations of functional agents within one case are effective. Each functional agent abates the pollutants to which it is specifically tailored. Typically, heavy metals are remediated by chemically combining with a functional agent. Impregnated carbons, for example, often form complexes with heavy metals. The presence of a plurality of functional agents does not diminish the effectiveness of any of them. In fact, the combination of functional agents generally has a synergistic effect. This synergistic effect is shown, for example, by comparing the removal rates for selenium, calcium and mercury in FIG. 5c with those in FIGS. 2c, 3c, and 4c. The functional agents were more effective when used in combination. As will be appreciated by those in the art, similar synergistic effects will be found with other combinations of multiple pollutants and multiple functional agents.

### EXAMPLE 1

### See FIGS. 1a-1c

Case:

| | |
|---|---|
| Materials of construction: | polycarbonate, water insoluble |
| Shape: | generally spherical |
| Size: | about 8 centimeters in diameter |
| Perforations: | about 2 millimeters in diameter |

Functional agents:

Activated carbon, about 120 grams in each case, granulated with an average particle size of approximately 4 to 5 millimeters, surface area of about 1000 square meters or more per gram, packing density of from about 120 to 150 grams per liter, and neutral pH. This activated carbon is available under the designation “BA” from Ajinomoto Fine-Techno Co., Inc. Activated Carbon Division.

Water:

| | |
|---|---|
| Volume: | about 200 liters |
| Temperature: | about 20 degrees centigrade |
| pH: | about 6.8 |
| Flow rate: | about 380 liters per hour |

Pollutants:

| | |
|---|---|
| Methylene Blue, | about 50 parts per million initial concentration |
| As | about 2.00 parts per million initial concentration |
| Pb | about 2.00 parts per million initial concentration |
| Cu | about 2.00 parts per million initial concentration |
| Cr | about 2.00 parts per million initial concentration |
| Se | about 2.00 parts per million initial concentration |
| Cd | about 2.00 parts per million initial concentration |
| Mo | about 2.00 parts per million initial concentration |
| Ni | about 2.00 parts per million initial concentration |
| Zn | about 2.00 parts per million initial concentration |
| Sb | about 2.00 parts per million initial concentration |
| Ca | about 2.00 parts per million initial concentration |
| Hg | about 2.00 parts per million initial concentration |

The body of water was confined in a tank and was continually circulated by pump so that the body of water was continuously flowing through the tank. See FIG. 16 for a diagrammatic representation of the system. The body of water in the tank was generally cylindrical with the axial length approximately one and one-half times the diameter. The system at any one time during operation had approximately 190 liters in the tank and about 10 liters in the external recirculation system. Forty packages were placed in the body of water at the beginning of this Example. The packages sank to the bottom of the tank (See, for example, FIG. 16). This Example was run at substantially constant conditions of temperature, flow rate, and pH for about 240 minutes. The package is shown diagrammatically in FIG. 1a, wherein the water insoluble, water pervious polycarbonate case is illustrated at 10, a typical perforation in the case is shown at 11, and the activated carbon is illustrated at 12. The effect of the presence of the package on the concentration of methylene blue is shown in FIG. 1b. The concentration of the methylene blue in the water was quickly reduced to approximately 1 parts per million. The effect on the concentrations of the metals is shown in FIG. 1c. The effect of the treatment with activated carbon on the concentration of the metals was negligible. At the conclusion of this Example, substantially all of the functional agent 12 remained in the case 10.

### EXAMPLE 2

### See FIGS. 2a-2c

Case:

| | |
|---|---|
| Materials of construction: | polycarbonate, water insoluble |
| Shape: | generally spherical |
| Size: | about 8 centimeters in diameter |
| Perforations: | about 2 millimeters in diameter |

Functional agents:

Impregnated carbon, about 120 grams per case, powder encased within water permeable paper bags, about −12 +80 mesh (less than about 1.3 millimeters average diameter), surface area of about 1,000 square meters per gram, packing density of about 120-150 grams per liter, and neutral pH. The carbon was impregnated and treated so as to be adapted to form a complex with heavy metal ions. This impregnated carbon is available under the designation “GS-B” from Ajinomoto Fine-Techno Co., Inc. Activated Carbon Division.

Water:

| | |
|---|---|
| Volume: | about 200 liters |
| Temperature: | about 20 degrees centigrade |
| pH: | about 6.8 |
| Flow rate: | about 380 liters per hour |

Pollutants:

The same as Example 1

The body of water was confined in a tank and was continually circulated by pump so that the body of water was continuously flowing through the tank. The test setup and operation were as described in Example 1, above. See also FIG. 16. Forty packages were placed in the body of water at the beginning of this Example. The packages were fully submerged in the body of water. This Example was run at substantially constant conditions of temperature, flow rate, and pH for about 240 minutes. The package is shown diagrammatically in FIG. 2a, wherein the pervious polycarbonate case is illustrated at 14, and the impregnated carbon is illustrated at 16. A typical perforation in the case is shown at 15. The effect on the concentration of methylene blue is shown in FIG. 2b. The concentration of the methylene blue was quickly reduced by about 18 parts per million to a level of approximately 32 parts per million. The effect on the concentrations of the metals is shown in FIG. 2c. The effect of the treatment on the concentration of the metals was significant. At the conclusion of this Example substantially all of the functional agent 16 remained in the case 14.

### EXAMPLE 3

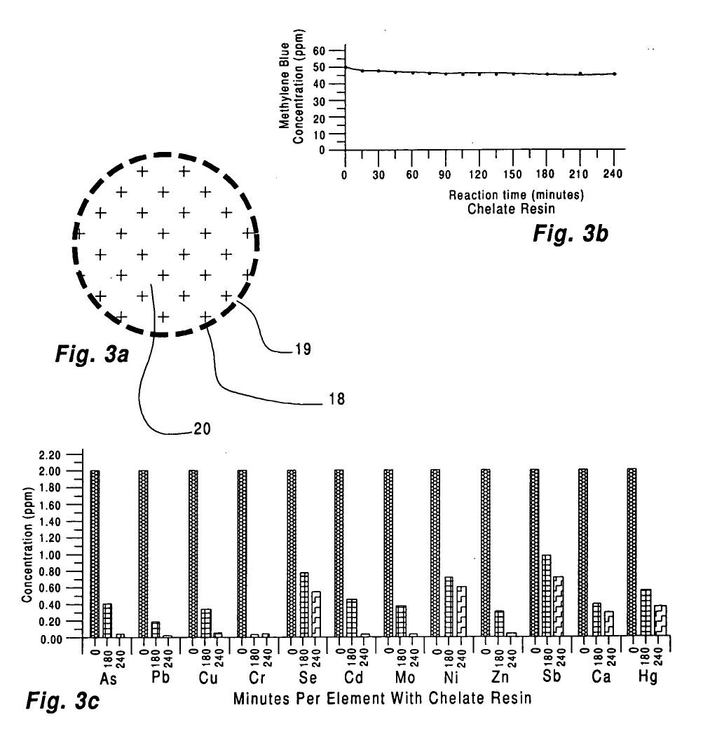

### See FIGS. 3a-3c

Case:

| | |
|---|---|
| Materials of construction: | polycarbonate, water insoluble |
| Shape: | generally spherical |
| Size: | about 8 centimeters in diameter |
| Perforations: | about 2 millimeters in diameter |

Functional agents:

Chelate resin in the form of porous polymer beads encased within a porous paper bag with a high wet tear strength, 10 grams per case, average particle size of about 0.3 to 2 millimeters, packing density of about 720 grams per liter, surface area of approximately 1.8 square meters or less per gram, specific gravity of about 1.1, available from Ajinomoto Fine-Techno Co., Inc. Activated Carbon Division under the designation “SB”.

Water:

| | |
|---|---|
| Volume: | about 200 liters |
| Temperature: | about 20 degrees centigrade |
| pH: | about 6.8 |
| Flow rate: | about 380 liters per hour |

Pollutants:

The same as Example 1

The body of water was confined in a tank and was continually circulated by pump so that the body of water was continuously flowing through the tank. The test setup and operation were as described in Example 1, above. See also FIG. 16. Forty packages were placed in the body of water at the beginning of this Example 3. The packages were fully submerged in the body of water. The Example was run at substantially constant conditions of temperature, flow rate, and pH for about 240 minutes. The package is shown diagrammatically in FIG. 3a, wherein the pervious polycarbonate case is illustrated at 18, and the chelate resin is illustrated at 20. A typical perforation in the case is shown at 19. The effect on the concentration of methylene blue is shown in FIG. 3b. The concentration of the methylene blue was slowly reduced by about 4 parts per million to a level of approximately 46 parts per million. The effect on the concentrations of the metals is shown in FIG. 3c. The effect of the treatment on the concentration of the metals was significant. At the conclusion of the Example, substantially all of the functional agent 20 remained in the case 18.

### EXAMPLE 4

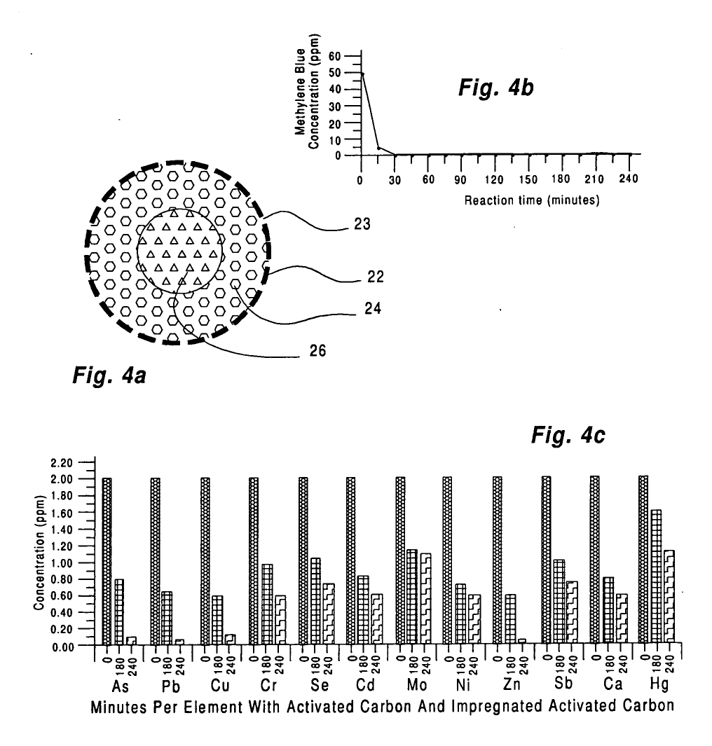

### See FIGS. 4a-4c

Case:

| | |
|---|---|
| Materials of construction: | polycarbonate, water insoluble |
| Shape: | generally spherical |
| Size: | about 10.5 centimeters in diameter |
| Perforations: | about 3 millimeters in diameter |

Functional agents:
Activated carbon, about 120 grams, as described in Example 1 above, and
Impregnated carbon, about 120 grams, as described in Example 2 above

Water:

| | |
|---|---|
| Volume: | about 200 liters |
| Temperature: | about 20 degrees centigrade |
| pH: | about 6.8 |
| Flow rate: | about 380 liters per hour |

Pollutants:

The same as Example 1

The body of water was confined in a tank and was continually circulated by pump so that the body of water was continuously flowing through the tank. The test setup and operation were as described in Example 1, above. See also FIG. 16. Forty packages were placed in the body of water at the beginning of this Example. The packages were fully submerged in the body of water. The Example was run at substantially constant conditions of temperature, flow rate, and pH for about 240 minutes. The package is shown diagrammatically in FIG. 4a, wherein the pervious polycarbonate case is illustrated at 22, the activated carbon is illustrated at 24, and the impregnated carbon is illustrated at 26. A typical case perforation is shown at 23. The effect on the concentration of methylene blue is shown in FIG. 4b. The concentration of the methylene blue was quickly reduced to a level that was barely detectable. The effect on the concentrations of the metals is shown in FIG. 3c. The effect of the treatment on the concentration of the metals was significant. The combination of functional agents is effective in abating both the heavy metal pollutants and the pollutants that are simulated by the methylene blue. At the conclusion of the Example substantially all of the functional agents 24 and 26 remained in the case 22. The functional agents are shown arranged concentrically in FIG. 4a only for the purposes of illustration. As will be understood by the art these functional agents can be partially or completely mixed, if desired.

### EXAMPLE 5

### See FIGS. 5a-5c

Case:

| | |
|---|---|
| Materials of construction: | polycarbonate, water insoluble |
| Shape: | generally spherical |
| Size: | about 16 centimeters in diameter |
| Perforations: | about 2 millimeters in diameter |

Functional agents:
Activated carbon, about 120 grams, as described in Example 1
Impregnated carbon, about 120 grams, as described in Example 2
Chelate resin, about 10 grams, as described in Example 3

Water:

| | |
|---|---|
| Volume: | about 200 liters |
| Temperature: | about 20 degrees centigrade |
| pH: | about 6.8 |
| Flow rate: | about 380 liters per hour |

Pollutants:

The same as Example 1

The body of water was confined in a tank and was continually circulated by pump so that the body of water was continuously flowing through the tank. The test setup and operation were as described in Example 1. See also FIG. 16. Forty packages were placed in the body of water at the beginning of this Example. The packages were fully submerged in the body of water. The Example was run at substantially constant conditions of temperature, flow rate, and pH for about 240 minutes. The package is shown diagrammatically in FIG. 5a, wherein the pervious polycarbonate case is illustrated at 28, the activated carbon is illustrated at 30, the impregnated carbon is illustrated at 32, and the chelate resin is illustrated at 34. A typical perforation is shown at 29. The effect on the concentration of methylene blue is shown in FIG. 5b. The concentration of the methylene blue was quickly reduced from about 50 parts per million to a level of approximately 0.73 parts per million. The effect on the concentrations of the metals is shown in FIG. 5c. The effect of the treatment on the concentration of the metals was significant. The combination of functional agents was more effective than when they were used independently. At the conclusion of the Example substantially all of the functional agents 30, 32, and 34 remained in the case 28. The functional agents are shown arranged concentrically in FIG. 5a only for the purposes of illustration. As will be understood by the art these functional agents can be partially or completely mixed, if desired.

### EXAMPLE 6

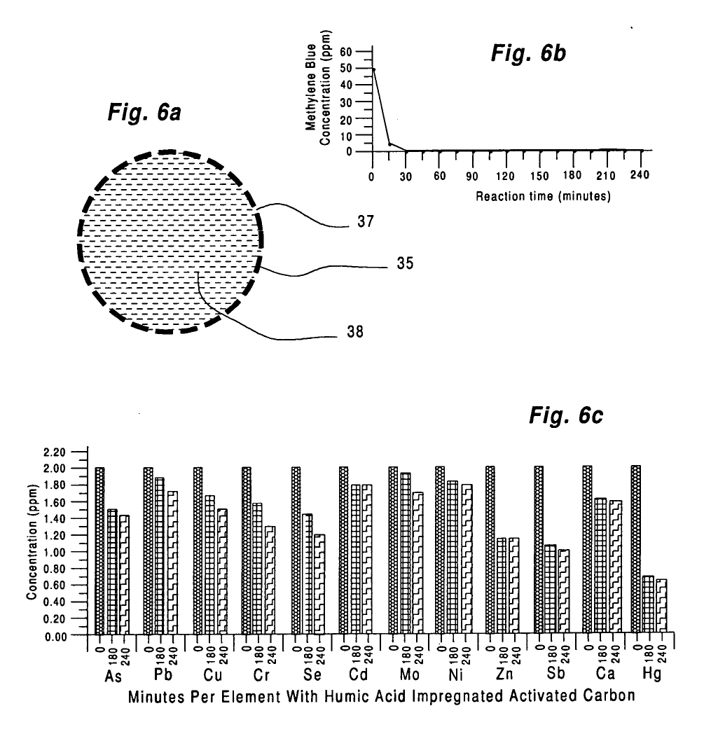

### See FIGS. 6a-6c

Case:

| | |
|---|---|
| Materials of construction: | polycarbonate, water insoluble |
| Shape: | generally spherical |
| Size: | about 8 centimeters in diameter |
| Perforations: | about 2 millimeters in diameter |

Functional agents:

Activated carbon impregnated with fumic acid in the amount of about 120 grams, granulated with an average particle size of from approximately 4 to 5 millimeters, a surface area of at least 1,000 square meters per gram, a packing density of from about 120 to 150 grams per liter, and a neutral pH. This plain activated carbon is available under the designation “BA” from Ajinomoto Fine-Techno Co., Inc., Activated Carbon Division.

Water:

| | |
|---|---|
| Volume: | about 200 liters |
| Temperature: | about 20 degrees centigrade |
| pH: | about 6.8 |
| Flow rate: | about 380 liters per hour |

Pollutants:

The same as Example 1

The fumic acid impregnated activated carbon was produced by selecting a reaction vessel and placing about 100 grams of activated carbon placed in it. About 1 liter of about 1 percent aqueous fumic acid was added to the reaction vessel. The activated carbon was allowed to remain in the reaction vessel for about 2 hours. It was then removed and washed three times with distilled water. The fumic acid impregnated activated carbon was found to be very effective in removing heavy metals from waste water. While not wishing to be bound by any theory, it is believed that the surface of the impregnated activated carbon complexes with the metallic ions.

Fumic acid occurs naturally (a naturally occurring polymer resulting from the decay of organic matter) as an undesired pollutant in many bodies of water. It has been discovered, as illustrated by this Example, that if fumic acid is present as a pollutant, it will combine with plain activated carbon. This removes the fumic acid pollutant from the water. The resulting fumic acid impregnated activated carbon will then combine with and remove heavy metals from the body of water. In effect, one pollutant is used to generate a reagent in situ that will remove a second pollutant.

The body of water was confined in a tank and was continually circulated by pump so that the body of water was continuously flowing through the tank. The test setup and operation were as described in Example 1. See also FIG. 16. Forty packages were placed in the body of water at the beginning of this Example. The packages were fully submerged in the body of water. The Example was run at substantially constant conditions of temperature, flow rate, and pH for about 240 minutes. The package is shown diagrammatically in FIG. 6a, wherein the pervious polycarbonate case is illustrated at 35, the fumic acid impregnated activated carbon is illustrated at 38. The perforations in the case are shown, for example, at 37. The effect on the concentration of methylene blue is shown in FIG. 6b. The concentration of the methylene blue was quickly reduced to a level of approximately 0.08 parts per million. The effect on the concentrations of the metals is shown in FIG. 6c. The effect of the treatment on the concentration of the metals was significant. At the conclusion of the Example substantially all of the functional agent 38 remained in the case 35.

### EXAMPLE 7

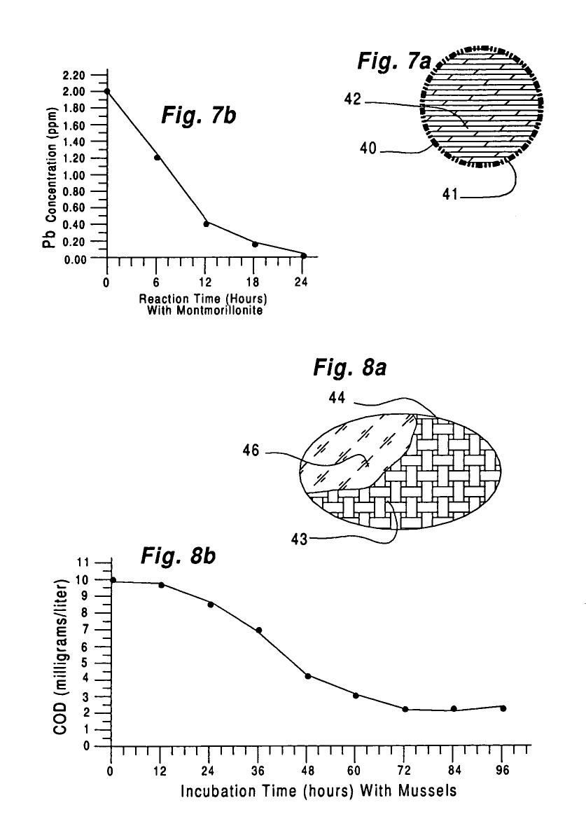

### See FIGS. 7a and 7b

Case:

| | |
|---|---|
| Materials of construction: | vinyl acetate, water insoluble |
| Shape: | generally spherical |
| Size: | about 10 centimeters in diameter |
| Perforations: | about 2 millimeters in diameter |

Functional agents:
montmorillonite, about 80 grams, average size of approximately 2 centimeters

Water:

| | |
|---|---|
| Volume: | about 200 liters |
| Temperature: | about 20 degrees centigrade |
| pH: | about 6.8 |
| Flow rate: | about 380 liters per hour |

Pollutants:
Pb about 2.00 parts per million initial concentration

The body of water was confined in a tank and was continually circulated by pump so that the body of water was continuously flowing through the tank. The test setup and operation were as described in Example 1. See also FIG. 16. Forty packages were placed in the body of water at the beginning of this Example. The packages were fully submerged in the body of water. The Example was run at substantially constant conditions of temperature, flow rate, and pH for about 240 minutes. The package is shown diagrammatically in FIG. 7a, wherein the pervious, soluble vinyl acetate case is illustrated at 40, and the montmorillonite is illustrated at 42. The perforations in the case are shown, for example, at 41. The effect on the concentrations of the lead is shown in FIG. 7b. The effect of the treatment on the concentration of lead was significant, reducing it to about 0.1 parts per billion in 24 hours. At the conclusion of the Example substantially all of the functional agent 42 remained in the case 40.

### EXAMPLE 8

### See FIGS. 8a and 8b

Case:

| | |
|---|---|
| Materials of construction: | bamboo, biodegradable |
| Shape: | generally spheroidal basket of woven bamboo |
| | (generally football shaped) |
| Size: | about 10 centimeters in diameter |
| Perforations: | about 2 millimeters in diameter in end caps |
| | only |

Functional agents:
Anodonta mussels, about 80 grams, average size of about 2.1 centimeters

Water:

| | |
|---|---|
| Volume: | about 200 liters |
| Temperature: | about 19 degrees centigrade |
| pH: | about 7.0 |
| Flow rate: | about 380 liters per hour |

Pollutants:
the body of water had an initial COD (chemical oxygen demand) value of about 10 milligrams per liter.

The body of water was confined in a tank and was continually circulated by pump so that the body of water was continuously flowing through the tank. The test setup and operation were as described in Example 1. See also FIG. 16. Forty packages were placed in the body of water at the beginning of this Example. The packages were fully submerged in the body of water. The Example was run at substantially constant conditions of temperature, flow rate, and pH for about 24 hours. The package is shown diagrammatically in FIG. 8a, wherein the pervious woven bamboo case is illustrated at 44. The case 44 is shown partially broken away to show the mussels 46 that are within the case. The perforations between the woven bamboo strips are illustrated, for example, at 43. The effect on the COD value of the body of water is shown in FIG. 8b. The effect of the treatment on the COD value was significant, reducing it to about 3 milligrams per liter in about 96 hours. At the conclusion of the Example substantially all of the functional agent (mussels) 46 remained in the case 44. The Mussels remained in the basket of Bamboo until the basket collapsed naturally. Th polluted water carried the organisims into the baskets where they were eaten by the Mussels. Depending on the conditions in the environment, such as temperature, the kinds of microorganisms present, and the like, the bamboo basket will take from approximately one-half to two years to collapse.

### EXAMPLE 9

### See FIGS, 9a and 9b

Case:

| | |
|---|---|
| Materials of construction: | biodegradable aliphatic polyester resin |
| | (this resin is available from Showa |
| | Highpolymer Co. Ltd. under the designation |
| | “Bionolle”) |
| Shape: | generally spherical |
| Size: | about 10 centimeters in diameter |
| Perforations: | about 2 millimeters in diameter |

Functional agents:
Rice chaff, about 20 grams, particle size of approximately 8 millimeters
Tubificids (aquatic worms which live in colloidal sediment in water), about 80 grams

Water:

| | |
|---|---|
| Volume: | about 200 liters |
| Temperature: | about 25 degrees centigrade |
| pH: | about 7.0 |
| Flow rate: | about 380 liters per hour |

Pollutants:
water bloom (Anabaena) had been grown in the body of water

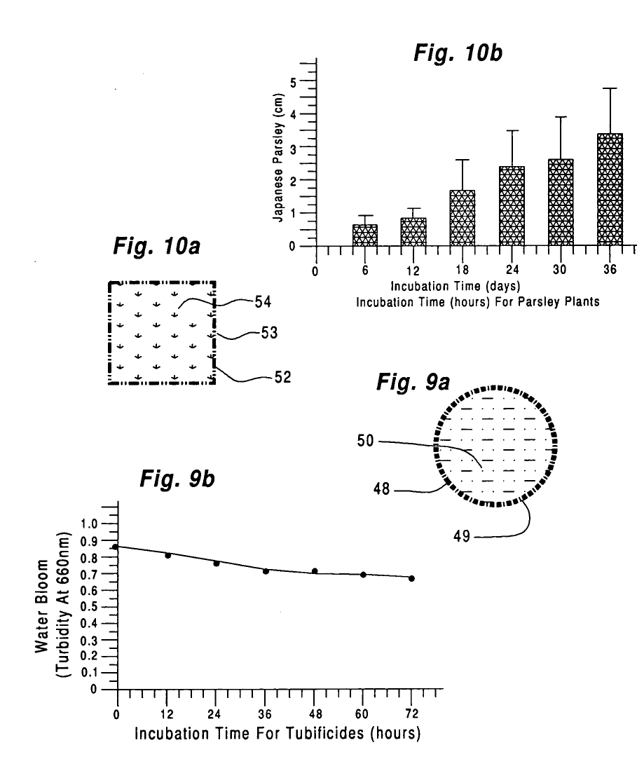

The body of water was confined in a tank and was continually circulated by pump so that the body of water was continuously flowing through the tank. The test setup and operation were as described in Example 1. See also FIG. 17. Forty packages were placed in the body of water at the beginning of this Example. The packages were suspended from floats in the body of water. The Example was run at substantially constant conditions of temperature, flow rate, and pH for about 72 hours. The package is shown diagrammatically in FIG. 9a, wherein the pervious biodegradable case is illustrated at 48, and the functional agents are illustrated at 50.

The perforations are shown, for example, at 49. The effect on the water bloom is shown in FIG. 9b. The bloom concentration was measured as turbidity (absorbance at 660 nanometers). A 5 milliliter sample was pleased in a 10 milliliter test tube. The sample was stirred for 30 seconds, immediately placed in an absorbance meter, and the absorbance was measured. At the conclusion of the Example substantially all of the aquatic worms remained in the case 48. The case will collapse in approximately 6 to 12 months. Before the case collapses generally approximately 20 percent by weight of the aquatic worms will escape through the perforations in the case.

### EXAMPLE 10

### See FIGS. 10a and 10b

Case:

| | |
|---|---|
| Materials of construction: | biodegradable aliphatic polyester resin as |
| | described in Example 9, above. About every |
| | 100 grams of resin included about 0.15 mil- |
| | ligrams of Nitrogen in the form of potassium |
| | nitrate, about 0.15 milligrams of phos- |
| | phorous in the form of phosphoric acid, and |
| | about 0.15 milligrams of potassium in the |
| | form of potassium nitrate. |
| Shape: | generally cubic |
| Size: | about 10 centimeters on each edge |
| Perforations: | about 12 millimeters in diameter |

Functional agents:
20 Japanese parsley plants, about 0.5 centimeters in height
Zeolite (Al₂O₃: about 12 percent by weight, SiO₂: about 65.6 percent by weight, Fe₂O₃: about 1.1 percent by weight, CaO: about 2.9 percent by weight, MgO: about 0.8 percent by weight, K₂O: about 1.9 percent by weight, Na₂O: about 0.6 percent by weight)

Water:

| | |
|---|---|
| Volume: | about 120 liters |
| Temperature: | about 25 degrees centigrade |
| pH: | about 7.0 |
| Flow rate: | about 120 liters per hour |

Pollutants:
None

The body of water was confined in a tank and was continually circulated by pump so that the body of water was continuously flowing through the tank. At the beginning of this Example the water would not support the growth of aquatic plants. The test setup and operation were as described in Example 1. See also FIG. 16. Forty cubic packages were placed in the body of water at the beginning of this Example. The Example was run at substantially constant conditions of temperature, flow rate, and pH for about 36 days. The package is shown diagrammatically in FIG. 10a, wherein the pervious biodegradable case is illustrated at 52, and the functional agents are illustrated at 54. The perforations are shown, for example, at 53. The growth of the plants over the test period is shown diagrammatically in FIG. 10b. At the conclusion of this Example 10 substantially all of the biodegradable case 52 had decomposed.

Repeating this Example 10 using Japanese Parsley seeds instead of plants produces satisfactory results.

### EXAMPLE 11

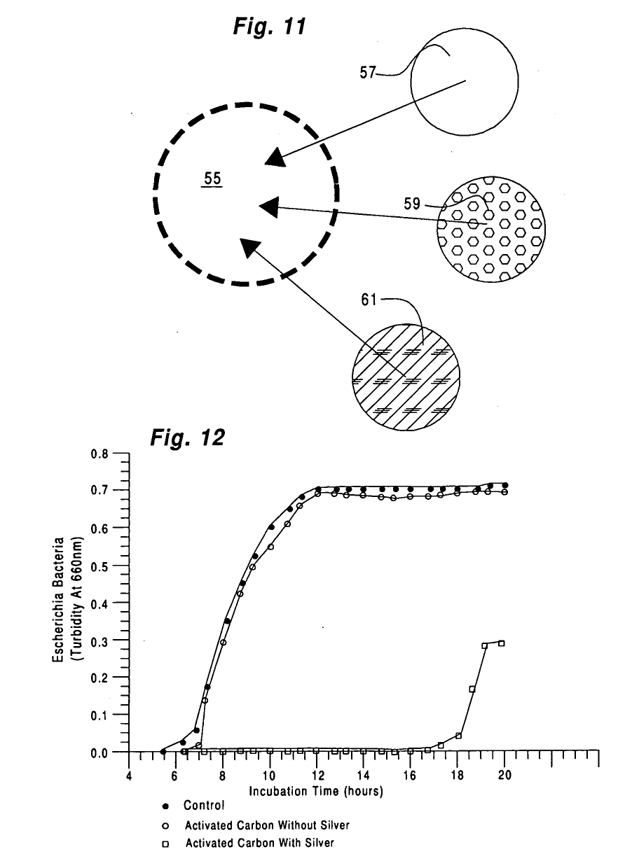

### See FIGS. 11-12

Case:

| | |
|---|---|
| Materials of construction: | polyethylene terephthalate |
| | (non-biodegradeable) |
| Shape: | generally spherical |
| Size: | about 8 centimeters in diameter |
| Perforations: | about 2 millimeters in diameter |

Functional agents:
silver-ion impregnated activated carbon, about 120 grams per case, about −12 +80mesh (less than about 1.3 millimeters average diameter), encased within water permeable paper bags, surface area of about 1,000 square meters per gram, packing density of about 120-150 grams per liter, and neutral pH. This impregnated carbon is available under the designation “WHA” from Takeda Chemical Industries, Ltd.

Water:

| | |
|---|---|
| Volume: | about 180 liters |
| Temperature: | about 37 degrees centigrade |
| pH: | about 5.5 |
| Flow rate: | about 80 liters per hour |

Pollutants:
Escherichia coli (Ttypto-soya Broth)

The respective bodies of water for each of the 3 samples were confined in separate tanks. In each tank the water was continually circulated by pump so that the body of water was continuously flowing. The test setup and operation were as described in Example 1. See also FIG. 16 for the experimental set-up. Forty packages were placed in each body of water at the beginning of this Example. As indicated in FIG. 11, the interior 55 of a perforated case was empty, as indicated at 57, or filled with activated carbon, see 59, or silver impregnated activated carbon, see 61. The Example was run at substantially constant conditions of temperature, flow rate, and pH for about 20 hours. As shown in FIG. 12, after about 12 hours of culturing the control and the sample without the silver ion showed an increase in turbidity to about 0.7 nanometers while the sample with the silver ion remained clear. Between about 18 and 20 hours the turbidity of the silver ion containing sample increased to about 0.28 nanometers. The objective of this Example was to establish that bacterial growth could be inhibited using a package according to the present invention. The 3 different samples were as follows: 1: Control, 2: Activated carbon, which contains silver ion, and 3: Activated carbon, which does not contain silver ion.

### EXAMPLE 12

Where microorganisms are employed to improve water quality, the water quality deteriorates when there is not enough oxygen in the water to keep the organisms alive. About 120 grams of the mineral bakuhanseki (functional agent) having an average particle size of about 1 centimeter were placed in each of Forty spherical water insoluble perforated (about 2 millimeters in diameter) polycarbonate cases (about 8 centimeter diameter) and immersed for about 6 hours in 200 liters of deaerated water (initially with about 0.8 milligrams of dissolved oxygen per liter) in a tank. This mineral, bakuhanseki, typically releases oxygen in water. The water was continuously recirculated through the tank. A flow rate of 60 liters per hour was maintained. The water was held at a temperature of about 20 degrees centigrade and a pH of about 7.0. The dissolved oxygen content of the water was observed to increase. At 3 hours the dissolved oxygen content of the water was about 18 milligrams of dissolved oxygen per liter, more than sufficient to sustain microorganisms. At the conclusion of this Example substantially all of the functional agent remained in the case.

### EXAMPLE 13

In this Example, the resin of the case was mixed with activated carbon. Activated carbon was also confined in pervious paper bags within the carbon-loaded cases. These water treatment systems were used to effectively absorb oil from water. The case was molded from vinyl chloride resin intimately mixed with activated carbon in the ratio of about 0.5:100 by weight of activated carbon to resin. The cases were water insoluble, spherical, about 8 centimeters in diameter, and with 2 millimeter perforations through the walls thereof. About 120 gram portions of powdered activated carbon were placed in each of 40 different cases. The activated carbon had an average particle size of less than about 2 millimeters, which is the size of the perforations through the walls of the cases. To retain the fine particles of activated carbon within the case they were placed in water pervious paper bags (similar to tea bags) that did not lose their structural integrity in water. This paper has a high wet tear strength and is sometimes described as “Japanese Paper”. This paper is widely available. The activated carbon had a surface area in excess of 1000 square meters per gram, a packing density of from about 120-150 grams per liter, and a neutral pH. This Activated carbon is available under the designation “Y-180” from Ajinomoto Fine-Techno Co., Inc. The same activated carbon was used in the case. The addition of activated to the material form which the case was molded was found to increase the removal rate of the oil pollutant by as much as 1.2 to 1.33 times as compared with cases that were molded without any activated carbon in the molding composition. About 200 liters of water was used. This body of water had a temperature of about 20 degrees centigrade, and a neutral pH. 10 grams of soybean oil was added to the water together with 0.2 grams of the emulsifier, glyceryl stearate, were added to the water. The body of water was confined in a tank and continuously circulated at a flow rate of about 180 liters per hour using the physical arrangement illustrated, for example, in FIG. 17. The previously described 40 cases were suspended in the body of oil contaminated flowing water for a period of about 1 hour. About 9.2 grams of the soybean oil had been removed by the end of the 1 hour period. Substantially all of the functional agent remained within the cases.

### EXAMPLE 14

Lightning bugs are at risk of becoming extinct in some areas because pollution is killing off their food source. The larva of lightning bugs feed on marsh snails. Pollution is causing the marsh snail population to die out. Restoring the marsh snail population would save both the marsh snail and the lightning bug. The purpose of this Example is to show that marsh snails can live in biologically polluted water, if the water is treated according to the present invention. In this example a water-soluble and biodegradable starch type resin case was loaded with activated carbon (to reduce COD in simulated sewage contaminated water), leaf mold (for the snails to eat), and marsh snails.

Case:

| | |
|---|---|
| Materials of construction: | This case is made from the biodegradability, |
| | water soluble resin of the corn starch, |
| | available under the designation “Savior |
| | Earth” from Kawata Chemical Co., Ltd. |
| Shape: | generally spherical |
| Size: | about 8 centimeters in diameter, |
| Perforation: | about 2 millimeters in diameter. |

Functional agent:
Activated carbon, 80 grams in each case, granulated with an average particle size of approximately 6 to 8 millimeters, surface area of about 1000 square meters or more per gram. This Activated carbon is available under the designation “WH2c” from Takeda Chemical Industries, Ltd.

Water:

| | |
|---|---|
| Volume: | about 200 liters |
| Temperature: | about 20 degrees centigrade |
| pH: | about 7.0 |
| Flow late: | about 180 liters per hour. |

Pollutants:
The body of water had an initial COD (Chemical oxygen demand) value of about 7 milligrams per liter.

The body of water was confined in a tank and was continually circulated by pump so that the body of water was continuously flowing though the tank. The test setup and operation were as described in Example 8.

About 10 grams of marsh snails with an average size of approximately 0.6 centimeters were placed in the case along with about 8 grams of leaf mould. The marsh snails and leaf mold were mixed with the activated carbon to form a pollution abatement package. The leaf mold had an average size of approximately 1 to 3 centimeters, and a packing density of about 100-120 grams per liter. The pollution abatement package had a neutral pH. Forty cases were placed in the body of water at the beginning of this Example. The packages were fully submerged in the body of water. The example was run at substantially constant conditions of temperature, flow rate, and pH for about 3 months. At this point the cases had substantially all collapsed and released their contents into the body of water. The condition of the water was such that the marsh snails continued to live.

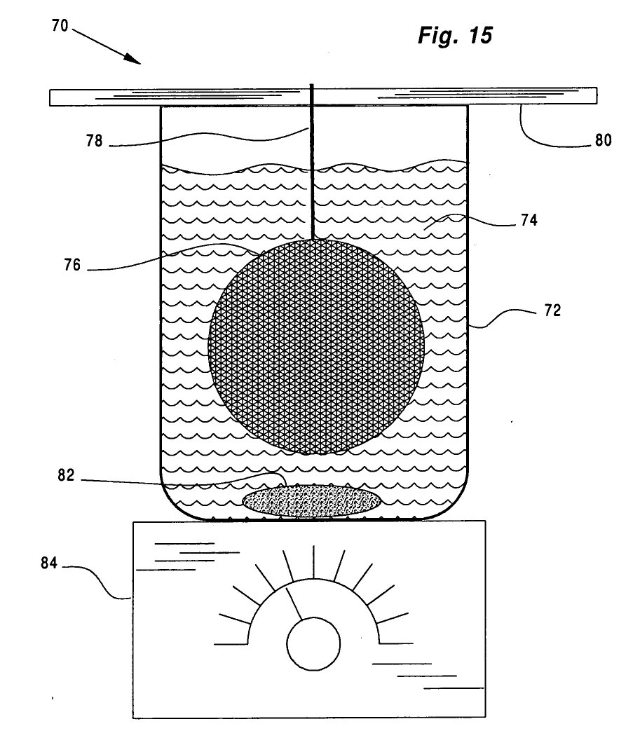

The following Tables 1 through 3 reflect tests that were conducted to test the effectiveness of the present invention in abating pollution from various metallic pollutants. The experimental set up 70 is indicated diagrammatically in FIG. 15. A beaker 72 is filled with about 1 liter of water 74. The water filled beaker 72 is positioned on a magnetic stirrer base 82, and a magnetically driven impeller 82 located within the beaker 72 is activated. Pollutants, as indicated in the following Tables 1-3, were introduced into the water. A pollution abating package 76 is introduced into the water. Package 76 is suspended from rod 80 by way of string 78 so that it does not rest on the bottom, and there is clearance for the magnetic stirrer to operate. The lower detection limits were as follows: arsenic, 0.2 micrograms per liter, copper, 0.5 micrograms per liter, chromium, 0.5 micrograms per liter, lead, 0.2 micrograms per liter, mercury, 1 micrograms per liter. The pollution abating package 76, and the setup and conditions for the metal pollutants were as follows:

Case:

| | |
|---|---|
| Materials of construction: | polycarbonate, water insoluble |
| Shape: | generally spherical |
| Size: | about 8 centimeters in diameter, |
| Perforation: | about 2 millimeters in diameter. |

Functional agent:
Chelate resin in the form of porous polymer beads encased within a water permeable cloth bag with a high wet tear strength, about 15 grams chelate resin per case, average particle size of approximately 0.3 to 2 millimeters, packing density of about 720 grams per liter, This Chelate resin is available under the designation “Chelate SB” from Ajinomoto Fine-Techno Co., Inc.

Water:

| | |
|---|---|
| Volume: | about 1 liter |
| Temperature: | about 20 degrees centigrade, |
| pH: | about 6.0 |

Pollutants:

The same body of water contained equal quantities by weight of dissolved arsenic, chrome, copper, mercury, and lead. Each dissolved metal was present in the first sample in the amount of about 10 micrograms per liter. Each metal was present in a second sample in the amount of about 25 micrograms per liter, in a third sample in the amount of about 50 micrograms per liter, and in a fourth sample in the amount of about 100 micrograms per liter.

TABLE 1
Metallic Pollutants

Pollutant
micrograms per liter

| Before | After | Temperature | Time | |
|---|---|---|---|---|
| Extraction | Extraction | Centigrade | Hours | pH |
| arsenic | | | | |
| 10 | 1.69 | 20 | 8 | 6 |
| 10 | 1.58 | 20 | 8 | 6 |
| 10 | 1.73 | 20 | 8 | 6 |
| 25 | 1.74 | 20 | 8 | 6 |
| 25 | 1.97 | 20 | 8 | 6 |
| 25 | 1.79 | 20 | 8 | 6 |
| 50 | 1.83 | 20 | 8 | 6 |
| 50 | 1.97 | 20 | 8 | 6 |
| 50 | 1.88 | 20 | 8 | 6 |
| 100 | 1.96 | 20 | 8 | 6 |
| 100 | 2.07 | 20 | 8 | 6 |
| 100 | 1.96 | 20 | 8 | 6 |
| Copper | | | | |
| 10 | Not Detected | 20 | | 6 |
| 10 | Not Detected | 20 | 8 | 6 |
| 10 | Not Detected | 20 | 8 | 6 |
| 25 | 0.51 | 20 | 8 | 6 |
| 25 | Not Detected | 20 | 8 | 6 |
| 25 | Not Detected | 20 | 8 | 6 |
| 50 | Not Detected | 20 | 8 | 6 |
| 50 | Not Detected | 20 | 8 | 6 |
| 50 | Not Detected | 20 | 8 | 6 |
| 100 | 0.86 | 20 | 8 | 6 |
| 100 | 1.44 | 20 | 8 | 6 |
| 100 | 0.90 | 20 | 8 | 6 |

TABLE 2
Metallic Pollutants

Pollutant
micrograms per liter

| Before | After | Temperature | Time | |
|---|---|---|---|---|
| Extraction | Extraction | Centigrade | Hours | pH |
| chromium | | | | |
| 10 | Not Detected | 20 | 8 | 6 |
| 10 | Not Detected | 20 | 8 | 6 |
| 10 | Not Detected | 20 | 8 | 6 |
| 25 | 0.53 | 20 | 8 | 6 |
| 25 | 0.50 | 20 | 8 | 6 |
| 25 | 0.78 | 20 | 8 | 6 |
| 50 | Not Detected | 20 | 8 | 6 |
| 50 | 0.68 | 20 | 8 | 6 |
| 50 | 0.54 | 20 | 8 | 6 |
| 100 | 1.32 | 20 | 8 | 6 |
| 100 | 0.86 | 20 | 8 | 6 |
| 100 | 0.69 | 20 | 8 | 6 |
| Lead | | | | |
| 10 | Not Detected | 20 | | 6 |
| 10 | Not Detected | 20 | 8 | 6 |
| 10 | Not Detected | 20 | 8 | 6 |
| 25 | Not Detected | 20 | 8 | 6 |
| 25 | Not Detected | 20 | 8 | 6 |
| 25 | 0.20 | 20 | 8 | 6 |
| 50 | 0.25 | 20 | 8 | 6 |
| 50 | Not Detected | 20 | 8 | 6 |
| 50 | Not Detected | 20 | 8 | 6 |
| 100 | 0.34 | 20 | 8 | 6 |
| 100 | 0.26 | 20 | 8 | 6 |
| 100 | 0.26 | 20 | 8 | 6 |

TABLE 3
Metallic Pollutants

Pollutant
micrograms per liter
Mercury

| Before | After | Temperature | Time | |
|---|---|---|---|---|
| Extraction | Extraction | Centigrade | Hours | pH |
| 10 | 1.46 | 20 | 8 | 6 |
| 10 | 1.57 | 20 | 8 | 6 |
| 10 | 1.65 | 20 | 8 | 6 |
| 25 | 2.05 | 20 | 8 | 6 |
| 25 | 2.20 | 20 | 8 | 6 |
| 25 | 2.27 | 20 | 8 | 6 |
| 50 | 3.15 | 20 | 8 | 6 |
| 50 | 2.68 | 20 | 8 | 6 |
| 50 | 2.67 | 20 | 8 | 6 |
| 100 | 6.61 | 20 | 8 | 6 |
| 100 | 6.38 | 20 | 8 | 6 |
| 100 | 5.98 | 20 | 8 | 6 |

The following Tables 4 through 6 were setup and conducted as described above with reference to Table 1-3 except that the dissolved metallic element were in separate samples. That is, there was only one dissolved metal in each sample of water.

TABLE 4
Metallic Pollutants

Pollutant
micrograms per liter
arsenic

| Before | After | Temperature | Time | |
|---|---|---|---|---|
| Extraction | Extraction | Centigrade | Hours | pH |
| 10 | 1.65 | 20 | 3 | 6 |
| 10 | 1.59 | 20 | 3 | 6 |
| 10 | 1.57 | 20 | 3 | 6 |
| 25 | 1.60 | 20 | 3 | 6 |
| 25 | 1.73 | 20 | 3 | 6 |
| 25 | 1.54 | 20 | 3 | 6 |
| 50 | 1.60 | 20 | 3 | 6 |
| 50 | 1.73 | 20 | 3 | 6 |
| 50 | 1.80 | 20 | 3 | 6 |
| 100 | 1.71 | 20 | 3 | 6 |
| 100 | 1.84 | 20 | 3 | 6 |
| 100 | 1.71 | 20 | 3 | 6 |

TABLE 5
Metallic Pollutants

Pollutant
micrograms per liter

| Before | After | Temperature | Time | |
|---|---|---|---|---|
| Extraction | Extraction | Centigrade | Hours | pH |
| chromium | | | | |
| 10 | Not Detected | 20 | 3 | 6 |
| 10 | Not Detected | 20 | 3 | 6 |
| 10 | Not Detected | 20 | 3 | 6 |
| 25 | Not Detected | 20 | 3 | 6 |
| 25 | Not Detected | 20 | 3 | 6 |
| 25 | Not Detected | 20 | 3 | 6 |
| 50 | Not Detected | 20 | 3 | 6 |
| 50 | Not Detected | 20 | 3 | 6 |
| 50 | Not Detected | 20 | 3 | 6 |
| 100 | Not Detected | 20 | 3 | 6 |
| 100 | Not Detected | 20 | 3 | 6 |
| 100 | Not Detected | 20 | 3 | 6 |
| Lead | | | | |
| 10 | Not Detected | 20 | 3 | 6 |
| 10 | Not Detected | 20 | 3 | 6 |
| 10 | Not Detected | 20 | 3 | 6 |
| 25 | Not Detected | 20 | 3 | 6 |
| 25 | Not Detected | 20 | 3 | 6 |
| 25 | Not Detected | 20 | 3 | 6 |
| 50 | Not Detected | 20 | 3 | 6 |
| 50 | Not Detected | 20 | 3 | 6 |
| 50 | Not Detected | 20 | 3 | 6 |
| 100 | Not Detected | 20 | 3 | 6 |
| 100 | 0.28 | 20 | 3 | 6 |
| 100 | 0.23 | 20 | 3 | 6 |

TABLE 6
Metallic Pollutants

Pollutant
micrograms per liter
mercury

| Before | After | Temperature | Time | |
|---|---|---|---|---|
| Extraction | Extraction | Centigrade | Hours | pH |
| 10 | 1.12 | 20 | 3 | 6 |
| 10 | 1.12 | 20 | 3 | 6 |
| 10 | 1.10 | 20 | 3 | 6 |
| 25 | 1.13 | 20 | 3 | 6 |
| 25 | 1.16 | 20 | 3 | 6 |
| 25 | 1.29 | 20 | 3 | 6 |
| 50 | 1.67 | 20 | 3 | 6 |
| 50 | 1.62 | 20 | 3 | 6 |
| 50 | .65 | 20 | 3 | 6 |
| 100 | 1.36 | 20 | 3 | 6 |
| 100 | 2.01 | 20 | 3 | 6 |
| 100 | 2.09 | 20 | 3 | 6 |

There is no specific restriction on the external shape of the case so long as it is the functional agent. For example, a net-like rigid, semi-rigid, or flexible material can be provided with, for example, a spherical, elliptical, cubic, rectangular parallelepiped, circular cylindrical, or conical shape, or the like.

Where the pollution abating system is intended to drift, roll, or in some way move without specific control within a body of water into a generally stagnant or generally quiescent region of the body of water, and then linger there, the shape of the case should be such that it will permit the system to float or be carried along by the flow until reaches still or slower flowing regions. Generally, rounded cases without external projections that catch and hold the case are preferred for this purpose. A preferred embodiment of the present invention involves such quiescent region seeking pollution abatement systems. Many types of pollution are higher in generally quiescent regions. Such an unattended system that automatically seeks regions of higher pollution without human guidance, direction, or control provides substantial advantages. Further, a rounded shape tends to permit the natural rolling action of the package to agitate or mix the contents of the case. This provides for the full utilization of the functional agents. A rounded shape also usually presents a high surface area to the polluted water. This also generally increases at least the degree and sometimes the rate of functional agent utilization. As will be understood by those in the art, suitable rounded shapes include, for example, various shapes including generally oblong, spherical, round ended cylinders, round cornered and edged boxes, and the like. As will be appreciated by those skilled in the art, many other rounded shapes are included within these teachings, and all of these many forms are intended to be included within the phrase “rounded form”.

The size (longest dimension) of the external part of the pollution abatement package is preferably in the range of approximately 0.5 to 60 centimeters, or more preferably in the range of 2 to 20 centimeters. This provides a package that is easy to handle manually and can be used in many different situations.

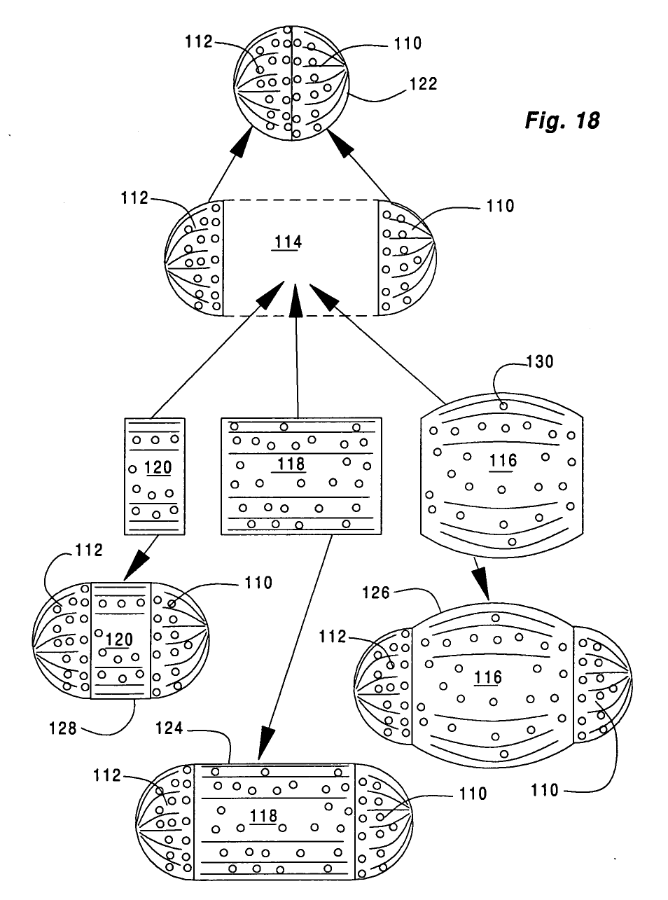

As shown, for example, in FIG. 18, cases according to the present invention can be constructed from a plurality of elements to provide a plurality of case forms. A number of different case elements can be prepared and inventoried for future use, as desired. As a particular pollution abatement problem arises the appropriate case elements can be selected and assembled to provide a case with a form, capacity, and other characteristics that are tailored to the particular situation. Two mating hemispherical cups 110 and 112 can be separated to provide a region 114 therebetween. If no other case elements are placed in region 114, as soon as the desired functional agent or agents is selected from inventory and placed in the hemispherical cups the cups are joined to form sphere 122. This case form is particularly desirable where maximum mobility is desired. If it is intended that the case be allowed to roll along the bottom of a stream, this spherical form 122 is preferred. If one or more of the intermediate case elements 120, 118, or 116 is joined with the hemispherical closure cups 110 and 112, the forms indicated at 124, 126, or 128 are generated. These forms allow more functional agent to be deployed in each case. They also allow, for example, internal capacity for the inclusion of weights or floatation devices as may be required to meet the specific situation. Where added capacity for functional agents is desired, case 126 provides a rounded form with substantial interior volume. Case forms 124 and 128, for example, are particularly suited for use with flotation devices where the package is generally suspended in water. The water pervious case elements are perforated to allow water to enter the cases. See typical perforation 130. The case elements can be joined together mechanically, by adhesive, by welding, or the like.

Polluted water typically contains more than one pollutant. Also, polluted waters often have different regions that require remediation with different agents and under different conditions. To be effective in unattended remediation, the pollution abatement packages need to be tailorable to the different pollutants and the different regions within the body of polluted water. This may require the use of different packages within one body of water. For example, a particular form of package may be required to move along the bottom of a flowing body of water while another may be required to float near the top or in stagnant regions. The nature of the pollution may be different in each region at least as to concentration, and probably as to kind. A moving region generally requires the use of a different package from a stagnant area. The same package is not likely to be entirely suitable for both purposes. Providing an inventory of separate case elements of various forms and a separate inventory of various functional agents from which suitable case forms and abatement agents can be selected allows great flexibility in devising an abatement regimen. When combined with an inventory of various different functional agents, an inventory of different case elements provides great flexibility in tailoring packages to meet the needs of a particular situation. Typically, a polluted body of water is surveyed to determine what the pollutants are and to identify the various regions of the body of water. There may be regions in the body of water where the flow rates are different, and there may be regions where the characteristics of the pollution differ. Pollution abatement packages are then assembled to meet the needs of each region. The inventories of case elements and functional agents can be maintained at or near the site of use, or distributed between various suppliers, or at a central warehouse, as may be desired.

The case protects the functional agent(s) contained within it from damage due to shock or friction. For example, when a water quality improving package of the present invention is thrown into a river, if it floats it flows along with the flow of river water, or if it does not float it may be rolled and carried along the bottom of the water. In this case, the water quality improving package may collide with obstacles such as rocks or stones. Even in such instances, the case protects the functional agents from being destroyed or scattered. Water quality improving packages of the present invention generally have simple shapes and structures as described above, and are lightweight and easy to produce. Because the functional agent is accommodated in and protected by the case, the functional agent is protected from being scattered away and lost when it is thrown loose into rivers and other water areas. Preferably, the water quality improving package is produced in a shape that rotates or rolls easily. When such a rollable package is thrown into a river or other water area, it tends to spontaneously moved along with the flow of water. When the package reaches an area where water is flowing slowly or not at all, the pollution is usually relatively aggravated in that area or region. The unconfined package tends to linger in such stagnate areas where it is needed most. As a result of this inherent pollution seeking characteristic, it is possible to easily carry out pollution abatement in the regions where it is needed most, all without human intervention. This pollution seeking characteristic is enhanced by keeping the weight of the package to less than about 10 pounds, and the size of its longest dimension to less than about 60 centimeters. The fundamental requirement for the package or system is that it tend move in the faster flowing parts of the stream, and to linger in the relatively slower moving regions of flow? This may result from the use of floatation devices that suspend the package or system in the body of water, or from the fact that the package is easily carried along the bottom of the body of water by a current. Where, for example, pollution is concentrated on or near the bottom of the body of water, it would be desirable to allow the package to reach the bottom. The moveability of the package or system should be tailored to the specific conditions where the pollution is to be abated. In a fast flowing body of water a weight may, for example, be added to the package so that the swift current will not immediately carry the package out of the region where it is needed.

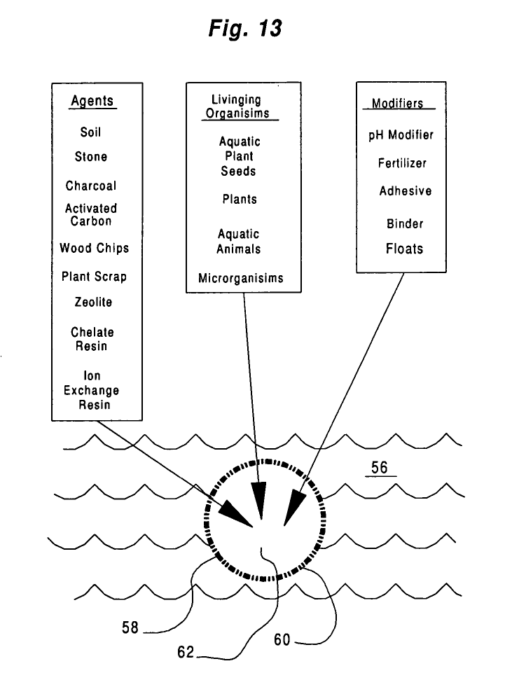

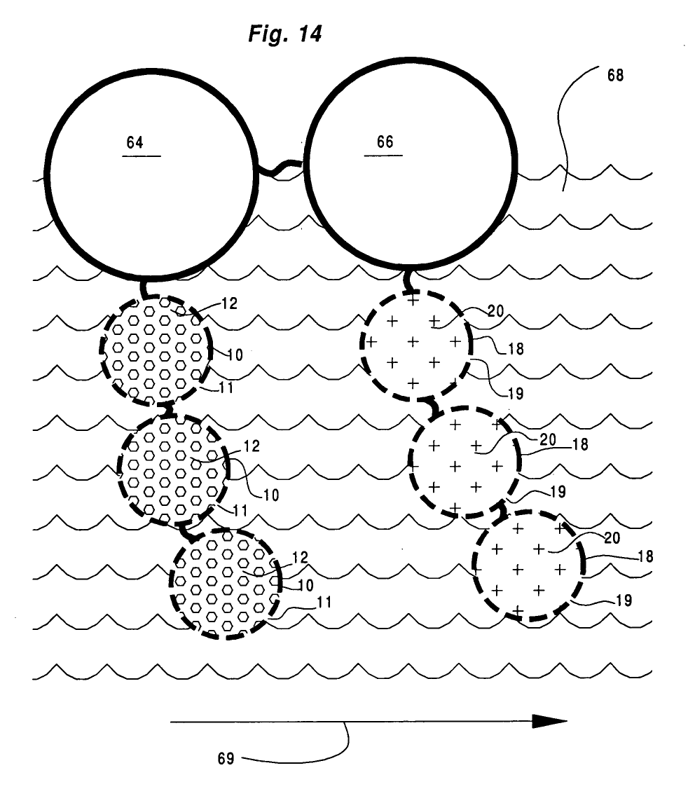

The water quality improving package is adapted to the inclusion of a wide variety of functional agents and water quality improving components. FIG. 13 illustrates generally a case 58 immersed within a body of water 56. The case 58 is generally spherical in shape so it is rollable responsive to the flow of water along the bottom of body of water 56. Water, although unconfined relative to the package, is free to enter and exit case 58 through perforations 60 in case 58. The interior 62 of case 58 is designed to hold one or more of a plurality of different materials, typical ones of which are illustrated in FIG. 13. The selection of functional agents and other materials to include in interior 62 is made depending on the nature of the pollutant that is to be abated. FIG. 14 is illustrative of an alternative embodiment where the cases 10 and 18 are suspended from floats 64 and 66, respectively, in a body of water 68 that is flowing in the direction indicated at 69. The embodiment of FIG. 14 is particularly adapted to a situation where the cases are tethered within a body of flowing water so that the stream, which is unconfined relative to the cases, flows past the water improvement packages.

The water pervious case can be constructed, for example, of rubber products such as butyl rubber, silicone rubber, urethane rubber, ethylene rubber, fluoro-rubber, acrylic rubber, natural rubber, reclaimed rubber, etc., synthetic resins such as polyethylene, polypropylene, polyvinyl acetate, vinyl chloride, polycarbonate, polyurethane, and the like. Also, metals such as aluminum, iron, stainless steel, copper, brass, and the like, or carbon materials such as carbon fiber can be used, if desired. Also, mixtures or complexes of these materials can be used. Various solid phase industrial and construction waste materials can be reduced to a finely divided state and mixed with molding resin to form the cases according to the present invention. Such waste materials include, for example, wood chips and sawdust, pulverized iron, shredded paper, shredded paper, chopped carbon, cotton, wool, and synthetic fibers, and the like. As will be appreciated by those skilled in the art, many other materials can also be utilized. The addition of, for example, calcium carbonate typically hardens the case, increases its density, and colors it white. Color may be advantageous where it is desired to retrieve the cases from the water at some later time. The addition of iron typically produces a dark or black colored case. Iron may also be used to help promote the growth of some organisms. The inclusion of some cellulose products in the molding resin may also promote the growth of various organisms. Various additives can be added to the molding resin for the case elements to adjust the density of the case.

The case can be constructed from biodegradable materials, if desired. Suitable biodegradable materials are decomposed by the activity of microorganisms or by physiologically active substances such as enzymes produced by microorganisms. A biodegradable case looses its original form when decomposed. When biodegradable material is used as the material for the case, the case itself disappears over time. Thus, the material of the case does not accumulate in the environment and no environmental pollution problem occurs. If biodegradable case is provided with a buoyancy unit, it is preferable that this buoyancy unit also be made of a biodegradable material. Suitable biodegradable materials include, for example, resins that are adapted to nourishing and growing microorganisms such as bacteria. Such materials include, for example, products of natural macromolecular substances derived from animal or plant materials, biodegradable synthetic polymers such as polylactic acid, mixtures of thermoplastic resin and starch, mixture of thermoplastic resin and chitin or chitosan, and the like, can be used. The rate or speed of degradation by microorganisms can be adjusted depending on the material of case construction, molding conditions, thickness of the material, moisture content, and the like. The size of openings or perforations in the case can be adequately adjusted depending on condition of intended use and size and shape of the functional agents that are to be encased within the case.

Suitable porous materials for use as functional agents within the case include one or more of, for example, silicate minerals such as zeolite, carbonaceous materials such as activated carbon, charcoal, Kanuma soil, diatomaceous earth, lapilli, and the like. Other suitable functional agents include, for example, impregnated carbon, chelate resin, silicate minerals such as montmorillonite, halloysite, gibbsite, alumino-silicate minerals such as allophane, macromolecular latex such as hydrophobic polystyrene latex, hydrophilic styrene/acrylic acid copolymer latex, peat-moss, vermiculite, artificial soil such as the soil used for activation of industrial waste, vegetable fibers such as wood fiber, seed fiber, coconut palm fiber, hemp, hemp palm, chaff, soybean cake, coffee lees, synthetic fibers such as nylon, polyethylene, polypropylene, inorganic fibers such as rock wool fiber, glass fiber, ceramic fiber, resins such as cellulose derivatives, polycarboxylic acid resin, polyacrylate resin, polyurethane resin, acrylic acid graft polymer, polyvinyl alcohol, and the like. Bactericidal or antibacterial active substances such as silver ion-impregnated zeolite, silver ion-impregnated activated carbon, silver ion-impregnated fiber, chlorine-containing agent, and the like, are also suitable for use as the functional agent. Such materials all act in one way or another to abate pollution, depending upon the nature of the pollutant. Not all functional agents will serve to abate all forms of pollution. Where, for example, pollution abatement requires the addition of oxygen to a body of polluted water, natural ores such as stromatolite, aragonite, and the like, can be used for supplying such oxygen to water. Where the pollution to be abated includes algae, various algae preventing agents such as, for example, triazine or ethanediamine compounds can be used to remove the algae.

Adhesive substances such as protein, starches, starch derivatives, agar-agar, pectin, carrageenan, cellulose, guar gum, pulp, carbohydrate, and the like, can be used to add viscosity to the functional agents, or as a binders. Such materials generally have no pollution abatement properties so they are not generally described as being functional agents. Various types of biodegradable resin latex can be blended into the functional agents to hold them in the case for a desired period of time.

Porous materials, when used as functional agents, have the effect of adsorbing and thus removing, for example, at least the following harmful substances: pigments, contaminant substances including suspended matter such as humin, organic chlorine type compounds such as trichloroethylene, trichloroethane, tetrachloroethylene, and the like, dioxins such as polychlorobanzo-para-dioxin, polychlorodibenzofurane, coplanar-polychlorobiphenyl, and the like, polar compounds such as aldehydes, amines, and the like, alcohols such as methanol, propanol, and the like, oil components such as heavy oil, vegetable oil, and the like, organic phosphorus compounds such as parathion, methylparathion, methyldimethone, and the like, phenol compounds such as phenol, catechol, pyrogallol, and the like, or harmful substances such as organic nitrogen, combinations thereof, and the like. The characteristics of conventional porous materials are known, and a particular porous material or combination of materials is selected to suit the particular pollutant that is to be abated.

Also, adsorbent materials that can be used as functional agents to remove harmful heavy metals such as Pb, Cd, As, Hg, Cr, Ni, B, U, Al, Cu, and the like, include, for example, activated carbon, impregnated activated carbon, chelate resin, silicate minerals such as montmorillonite, halloysite, gibbsite, and the like, alumino-silicate minerals such as allophane, macromolecular latex such as hydrophobic polystyrene latex, hydrophilic styrene/acrylic acid copolymer latex, and the like. The characteristics of conventional absorbent materials are known, and a particular absorbent material or combination of materials is selected to suit the particular pollutant that is to be abated.

An impregnated activated carbon that finds particular utility as an absorbent for metals is an activated carbon with a reformed surface. Such reformation can, for example, place a functional group such as carboxylic group, hydroxyl group, carbonyl group or the like on the surface of the activated carbon. The characteristics of such conventional materials are known, and a particular material or combination of materials is selected to suit the particular package that is to be used.

Further, peat-moss, vermiculite, and artificial soil such as the soil that is used for activating industrial waste, or serving as a base material for biological membrane processing, can be used as a functional agent according to the present invention. The following additional biological membrane base materials can also be used as a nourishing bed for useful microorganisms, and as a base material for biological membrane processing: vegetable fibers such as wood fiber, seed fiber, coconut palm fiber, hemp, hemp palm, chaff, soybean cake, coffee lees, and the like, synthetic fibers such as nylon, polyethylene, polypropylene, and the like, inorganic fibers such as rock wool fiber, glass fiber, ceramic fiber, and the like, resins such as cellulose derivatives, polycarboxylic acid resin, polyacrylate resin, polyurethane resin, acrylic acid graft polymer, polyvinyl alcohol, and the like. The characteristics of such conventional materials are known, and a particular material or combination of materials is selected to suit the particular package that is to be used.

The microorganisms that serve as functional agents include, for example, true fungi (Eumycetes) such as mold (Hyphomycetes), ray fungi (Actynomycetes), as well as bacteria. Microorganisms living, for example, in biological membrane base materials, function to continuously clean and purify water. The characteristics of such conventional materials are known, and a particular material or combination of materials is selected to suit the particular package that is to be used.

In the situation where harmful bacteria are present as pollutants in water, bactericidal or antibacterial active substances such as silver ion-impregnated zeolite, silver ion-impregnated activated carbon, silver ion-impregnated fiber, chlorine agent, and the like, can be selected and used for the purpose of removing or otherwise abating harmful bacteria. The characteristics of such conventional materials are known, and a particular material or combination of materials is selected to suit the particular package that is to be used.

Oxygen-supplying materials, for example, natural ores such as stromatolite, aragonite, and the like, can be used for the purpose of introducing oxygen into water. The characteristics of such conventional materials are known, and a particular material or combination of materials is selected to suit the particular package that is to be used.

Also, algae-preventive agents such as triazine compound or ethane-diamine may be used for the purpose of removing algae, which impair the external appearance of water areas. The characteristics of such conventional materials are known, and a particular material or combination of materials is selected to suit the particular package that is to be used.

Functional agents such as, for example, porous materials, adsorbent materials, biological membrane base materials, bactericidal and antibacterial substances, oxygen supplying materials, algae preventive materials, adhesive materials, and the like, can be used alone or in combination.

Aquatic animals or plants can be used as functional agents for the abatement of certain types of pollution, such as, for example, organic substances, nitrogen compounds, phosphoric acid, and the like. The characteristics of such conventional materials are known, and a particular material or combination of materials is selected to suit the particular package that is to be used. To add aquatic plants to the functional agents in a case, seeds, seedlings, or grown-up aquatic plants can be used. To add aquatic animals to the functional agents, eggs or grown-up aquatic animals can be added. It is also possible to add aquatic plants and aquatic animals in mixed state, or with other functional agents. The following the aquatic plants can, for example, be used: Eichhornia (water hyacinth), Phragmites (reed), Hippuris (marers tail), entibulariaceae, Ranunculus, Ceratophyllum (hornwort), Zosteraceae (eelgrass), Sicyos angulatus L., Egeria densa, and the like. Useful aquatic animals include, for example, the following: shellfishes such as Nucula, Nuculanidae, Arca arabica, Mytilus (sea mussel), Pteria brevialata, Veneracea, Myacea (soft-shell clam), Pholadomya, Dentalium, Hyriopsiris, Semisulcospira bensoni (marsh snail), Unio, Anodonta, fresh water mussel, fresh water clam, mud snail, and the like. Mollusca such as tibificid, Aeolosoma, Lumbriculus, Branchiobdellida, Haplotaxina, Criodrilus bathybates, Branchiura, Capitellida, lugworm, leech, and the like, can be used. Small aquatic plants and animals such as, for example, Bacillariophyceae (Diatomophyceae) or Phaephyceae (Fucophyceae), and animal planktons such as Daphnia (water flea), Ploima, and the like, can be used.

A particularly preferred form of the pollution abatement package according to the present invention includes a generally spherical case having a diameter of approximately 8 centimeters with a plurality of 2 millimeter perforations therethrough. The case is not water soluble, and it is not biodegradable. Particularly preferred functional agents for the abatement of heavy metal polluted waste water, such as industrial sewage, are a mixture of activated carbon and chelate resin. The activated carbon generally physically adsorbs the organics that are typically found in industrial sewage. The chelate resin binds with the heavy metals. Impregnated activated carbon can also be included in the pollution abatement package, if it is required to complex with a particular metal ion. The capabilities of the impregnated activated carbon, and the chelate resin can be tailored to combine preferentially with specific heavy metals. The selection of a particular chelate resin or impregnated carbon is dictated by the nature of the pollution that is to be abated. The package retains the pollutants that it removes from the water. Eventually the package is collected or settles to a quiet place in the flowing body of water where it stays unless disturbed.

The pollution abatement packages are suitable for use in naturally occurring streams, lakes, ponds, swamps, and the like. They are also suitable for use in holding tanks, settling ponds, defined channels, and the like. They are particularly effective, and very efficient of labor and capital investment when the body of water is left unconfined relative to these packages, although both may be confined, for example, in a settling pond. If time, effort, and capital expense are invested to create, for example, a filter through which a body of water is directed, the packages of this invention, while effective as a confined filter media, are not best utilized in this way. Such use as a captive filter media does not take full advantage of the packages capabilities.

What have been described are preferred embodiments in which modifications and changes may be made without departing from the spirit and scope of the accompanying claims. Clearly, many modifications and variations of the present invention are possible in light of the above teachings. It is therefore to be understood that, within the scope of the appended claims, the invention may be practiced otherwise than as specifically described.

1. Method of abating water pollution comprising:
selecting a polluted body of water containing at least one pollutant and having a first volume;
identifying said pollutant;
selecting a functional agent that is capable of abating at least said pollutant in said body of water;
enclosing said functional agent in a water pervious case to form a pollution abatement package, said pollution abatement package having a second volume, said second volume being at least 10 times less than said first volume;
placing said pollution abatement package within said body of water;
leaving said body of water unconfined relative to said abatement package; and
allowing said functional agent to abate said pollutant.

2. Method of abating water pollution according to claim 1 including selecting a polluted body of water containing a plurality of pollutants.

3. Method of abating water pollution according to claim 1 including selecting a polluted body of water containing a plurality of pollutants, and selecting a plurality of functional agents that are capable of abating at least said plurality of pollutants in said body of water.

4. Method of abating water pollution according to claim 1 including selecting a said water pervious case having a generally rounded form.

5. Method of abating water pollution according to claim 1 including selecting a water pervious case having a weight of less than approximately 10 pounds.

6. Method of abating water pollution according to claim 1 including selecting a water pervious case having its longest dimension less than approximately 60 centimeters.

7. Method of abating water pollution according to claim 1 including selecting a water pervious case having its longest dimension less than approximately 20 centimeters, and a weight of less than approximately 1 pound.

8. Method of abating water pollution in a body of polluted water wherein there are different flow rates including at least one relatively quiescent region generally having a first level of pollution, and at least one relatively moving region having a second level of pollution, said first level being greater than said second level, said method comprising:
selecting a pollution abatement package including a case member having a generally rounded form, and at least one functional agent confined within said case member, said pollution abatement package being adapted to being carried along by said relatively moving region and lingering in said relatively quiescent region;
placing said pollution abatement package in said body of polluted water; and
allowing said pollution abatement package to move freely in said body of polluted water and to linger in said relatively quiescent region.

9. Method of abating water pollution according to claim 1 including selecting a generally spherical case member.

10. Method of abating water pollution comprising:
selecting a polluted body of water containing at least one pollutant distributed unevenly within said polluted body of water, said pollutant being more concentrated in a polluted region, said polluted body of water having a first volume;
identifying said pollutant;
selecting a functional agent that is capable of abating at least said pollutant in said body of water;
enclosing said functional agent in a water pervious case to form a pollution abatement package, said pollution abatement package having a second volume, said second volume being at least 10 times less than said first volume;
placing said pollution abatement package within said body of water;
leaving said body of water unconfined relative to said abatement package;
allowing said pollution abatement package to move unattended and to linger in said polluted region; and
allowing said functional agent to abate said pollutant.

11. Method of abating water pollution comprising:
selecting a polluted body of water containing at least one pollutant, said polluted body of water including at least one rapidly flowing part and at least one region that is generally quiescent or slower flowing relative to said rapidly flowing part, said pollutant being more concentrated in said region, said polluted body of water having a first volume;
identifying said pollutant;
selecting a functional agent that is capable of abating at least said one pollutant in said body of water;
enclosing said functional agent in a water pervious case to form a pollution abatement package, said pollution abatement package having a second volume, said second volume being at least 10 times less than said first volume;
placing said pollution abatement package within said body of water;
leaving said body of water unconfined relative to said abatement package;
allowing said pollution abatement package to move unattended and to linger in said region; and
allowing said functional agent to abate said pollutant.

12. A method of abating water pollution according to claim 11 including allowing said pollution abatement package to float and move within said body of polluted water.

13. A method of abating water pollution according to claim 11 including allowing said pollution abatement package to settle to and move along the bottom of said body of polluted water.

14. A method of abating water pollution according to claim 11 wherein said polluted body of water includes a plurality of said pollutants, and providing a plurality of functional agents in said pollution abatement package, different ones of said plurality of functional agents being adapted to remediate different ones of said plurality of pollutants.

15. A method of abating water pollution comprising:
providing a plurality of functional agents each of which is capable of abating at least one form of pollution;
providing a water pervious case, said case being adapted to contain said functional agents, said case having a generally rounded form;
selecting a body of polluted water having at least one said form of pollution that is abatable;
selecting a said functional agent from said plurality of functional agents, said selected functional agent being capable of substantially abating at least said abatable form of pollution;
placing said selected functional agent in said water pervious case to form a pollution abatement package;
placing said pollution abatement package in said body of polluted water;
leaving said body of water unconfined relative to said abatement package; and
allowing said functional agent to substantially abate at least said abatable form of pollutant.

16. A method of abating water pollution according to claim 15 including selecting a body of water having a plurality of forms of pollution, and selecting a plurality of functional agents, the said selected plurality of functional agents being capable of abating substantially all said forms of pollution.

17. A method of abating water pollution according to claim 16 wherein said selected plurality of functional agents is less than all of said provided plurality of functional agents.

18. A method of abating water pollution according to claim 15 including providing a plurality of water pervious case elements and selecting from among said plurality of water case elements to form said water pervious case.

19. A method of abating water pollution comprising:
providing a plurality of functional agents each of which is capable of abating at least one form of pollution;
providing a plurality of separate case elements;
selecting a body of polluted water having a plurality of regions, each of said regions having different characteristics and at least one of said regions having at least one said form of pollution that is abatable and;
selecting one said functional agent from said plurality of functional agents, said selected functional agent being capable of substantially abating at least said abatable form of pollution;
selecting individual ones of said case elements, placing said one functional agent in said individual ones of said case elements and combining said individual ones of said case elements together to form a pollution abatement package adapted to remidiate at least said abateable form of pollution;
placing said selected functional agent in said water pervious case to form a pollution abatement package;
placing said pollution abatement package in said body of polluted water;
leaving said body of water unconfined relative to said abatement package; and
allowing said functional agent to move unattended to said at least one of said regions and to substantially abate at least said abatable form of pollutant.

20. A method of abating water pollution according to claim 19 including combining said individual ones of said case elements into a case member having a generally rounded form.

21. A method of abating water pollution according to claim 19 including preparing a different said pollution abatement package for each of said plurality of regions.

22. A method of abating water pollution comprising:
providing at least activated carbon;
providing a water pervious case, said case being adapted to contain said activated carbon;
selecting a body of polluted water containing polluting amounts of at least fumic acid and at least one heavy metal ion;
placing said activated carbon in said water pervious case to form a pollution abatement package;
placing said pollution abatement package in said body of polluted water;
allowing said activated carbon to remove at least some of said fumic acid from said body of polluted water to form a fumic acid impregnated activated carbon; and
allowing said fumic acid impregnated activated carbon to remove at least some of said heavy metal ion form said body of polluted water.

23. A water pollution abatement system comprising an inventory of different functional agents and an inventory of different case elements, individual ones of said different functional agents being adapted to abating individual pollutants in water, said case elements being adapted to being assembled into a plurality of water pervious cases having rounded forms, individual ones of said water pervious cases being adapted to holding therewithin at least individual ones of said functional agents when immersed within said water.

24. A water pollution abatement system according to claim 22 including floatation devices for generally suspending said water pervious cases within said water.
